(19) United States
(12) Patent Application Publication
(10) Pub. No.: US 2015/0032296 A1
(43) Pub. Date: Jan. 29, 2015

(54) AVIONICS SYSTEM ADAPTED FOR EMPLOYING SMARTPHONE TO INPUT-OUTPUT FLIGHT DATA

(71) Applicant: BELL HELICOPTER TEXTRON INC., Fort Worth, TX (US)

(72) Inventors: William D. Girard, Euless, TX (US); Brian E. Tucker, Fort Worth, TX (US)

(21) Appl. No.: 13/951,900

(22) Filed: Jul. 26, 2013

(51) Int. Cl. B64D 45/00

(52) U.S. Cl. CPC B64D 45/00
USPC 701/3

(57) ABSTRACT

A system and method configured to monitor aircraft flight performance data. The system includes a wireless transmitter in data communication with an avionics system of the aircraft, a portable wireless transceiver associated with the wireless transmitter, and a wireless database associated with the wireless transmitter. The method includes sensing flight performance data with the sensor, transmitting sensed flight performance data to the wireless transmitter, wirelessly transmitting the sensed flight performance data to the wireless database, and monitoring flight performance data with a display operably associated with the wireless database.

### BACKGROUND

1. Field of the Invention

The present application relates generally to aircraft avionics systems.

2. Description of Related Art

Aircraft avionics systems are well known in the art for control aircraft maneuverability. Prior to flight, the avionics systems are typically manually programmed with flight planning information. The manual process results in significant downtime, and in some scenarios, can result in mistakes due to incorrect input.

Conventional avionics systems can also be utilized to display and store flight performance information of the aircraft during flight. The information is useful for monitoring the aircraft performance, to assist with maintenance, and to provide feedback during pilot training.

Although the foregoing developments in the above-described system and method represent great strides, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a side view of a helicopter according to a preferred embodiment of the present application;

FIG. 2 is a perspective view of a tiltrotor aircraft according to an alternative embodiment of the present application; and

FIG. 3 is a simplified schematic of the fight performance monitoring, analysis, and feedback system in accordance with the preferred embodiment of the present application.

While the system and method of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the apparatus and method are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system of the present application overcomes problems commonly associated with conventional avionic systems and methods. Specifically, the system includes a transmitter that wirelessly transmits flight performance data from the aircraft avionics system to a wireless database. Further, the system includes a portable wireless transceiver that receives and transmits flight performance data and/or pilot information associated with the flight performance data to the wireless database. The system provides rapid and effective means to monitor the flight performance of the aircraft, and to provide monitoring and training of the pilot. The system is also adapted to upload flight planning information to the avionics system of the aircraft. Further detailed description of these features are provided below and illustrated in the accompanying drawings.

The system and method of the present application will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

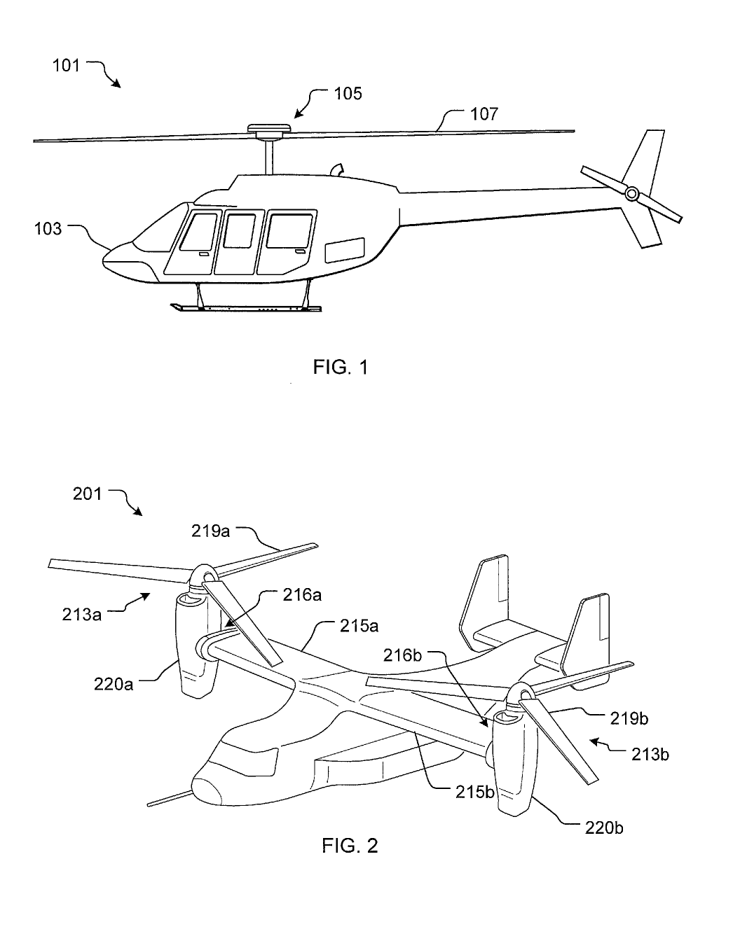

Referring now to the drawings wherein like reference characters identify corresponding or similar elements throughout the several views, FIG. 1 depicts an aircraft 101 in accordance with a preferred embodiment of the present application. In the exemplary embodiment, aircraft 101 is a helicopter having a fuselage 103 and a rotor system 105 carried thereon. A plurality of rotor blades 107 is operably associated with rotor system 105 for creating flight.

Although shown associated with a helicopter, it will be appreciated that the system of the present application could also be utilized with different types of rotary aircraft and vehicles. For example, FIG. 2 illustrates a tiltrotor aircraft 201 that utilizes the damper system in accordance with the present application.

Tiltrotor aircraft 201 includes rotor assemblies 213a and 213b that are carried by wings 215a and 215b, and are disposed at end portions 216a and 216b of wings 215a and 215b, respectively. Tilt rotor assemblies 213a and 213b include nacelles 220a and 220b, which carry the engines and transmissions of tilt rotor aircraft 201, as well as, rotor proprotors 219a and 219b on forward ends 221a and 221b of tilt rotor assemblies 213a and 213b, respectively. Tilt rotor assemblies 213a and 213b move or rotate relative to wing members 215a and 215b between a helicopter mode in which tilt rotor assemblies 213a and 213b are tilted upward, such that tilt rotor aircraft 201 flies like a conventional helicopter; and an airplane mode in which tilt rotor assemblies 213a and 213b are tilted forward, such that tilt rotor aircraft 201 flies like a conventional propeller driven aircraft.

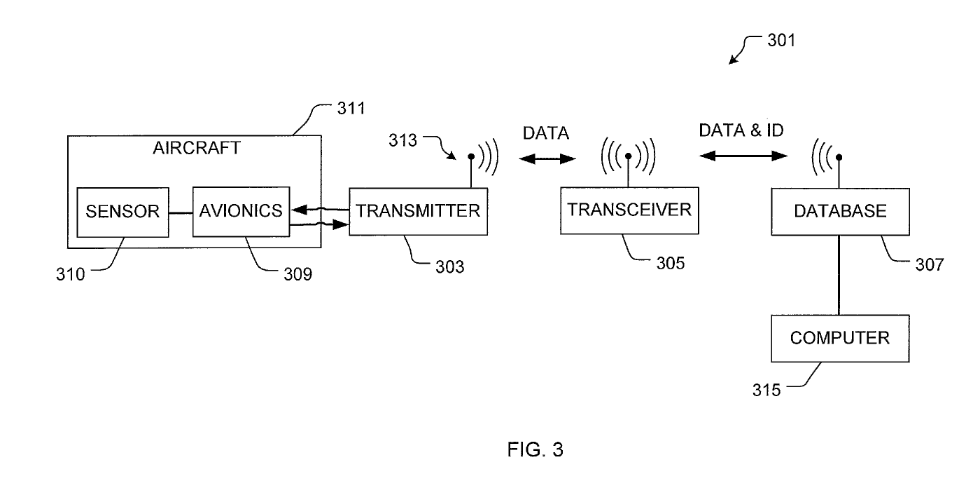

FIG. 3 shows a simplified schematic of system 301 according to the preferred embodiment of the present application. System 301 preferably includes one or more of a transmitter 303, a transceiver 305, and a database 307. It will be appreciated that the features of system 301 discussed herein are hereby incorporated in aircraft 101, 201, and other similarly suitable aircraft and/or vehicles.

Transmitter 303 is in data communication with an avionics system 309 associated with aircraft 311. During operation, a sensor 310 associated with avionics system 309 senses performance data of aircraft 311 during flight, which in turn is received, stored, and transmitted to transceiver 305.

In the preferred embodiment, transmitter 303 is a Secure Digital (SD) or a non-volatile memory card that is configured to receive, store, and/or transmit data to and from avionics system 309. To facilitate transmission, transmitter 303 includes a wireless device 313 configured to transmit data to and from transceiver 305. It will be appreciated that transmitter 303 could also be configured to fit within transceiver 305, e.g., a mini SD card fitted within a smartphone and/or portable tablet.

In the contemplated embodiment, transceiver 305 is a portable smartphone and/or tablet configured to receive data from transmitter 313 and relay the data to database 307. Transceiver 305 is also contemplated having a touch or voice key entry feature that enables a user to enter information to be relayed to avionics system 309 and/or database 307. For example, the pilot identification information associated with the flight performance data can be sent together to database 307.

Database 307 is configured to store data from transmitter 303 and can be operably associated with a computer 315 for viewing and analysis of the data via a computer display (not shown). In an alternative embodiment, database 307 could be adapted to send and receive data directly from transmitter 303, thereby eliminating the need for transceiver 305. It will be appreciated that database 307 could be configured to automatically populate aircraft and pilot logbooks with data received from the aircraft, e.g., flight hours, landings, and so forth. Conventional methods include the process of manually keeping the logbooks, and the above method would reduce the record-keeping burden and reduce the manual entry errors.

One feature believed unique to the present application is utilizing wireless means to transfer secured information from avionics system 309 to database 307. This process is achieved enables rapid and efficient means to convey data with little to no flight downtime. It should be understood that there are many different means of wireless communications that are contemplated, including, but not limited to, radio waves such as Bluetooth technology, cellular, Wi-Fi, Near Field Communication, and so forth. It is contemplated utilizing short-range wireless communication from transmitter 303 to transceiver 305 and utilizing long-range communication from transceiver 305 to database 307.

In one contemplated method of utilizing system 301, transmitter 303, with wireless communication capabilities, is inserted into the avionics system 309 prior to flight. Data, such as flight performance data, is written to transmitter 303 during flight, and once the flight is over, the user can then download the data directly to transceiver 305 or command the data to be sent directly to database 307, e.g, internet share or network. Once received by database 307, the user can analyze the data using third party software via computer 315.

In an alternative method, transmitter 303 could be configured to facilitate automatic download of flight performance data to either transceiver 305 and/or database 307 after flight.

It is also contemplated utilizing system 301 to upload flight planning data to avionics system 309. For example, a user can enter flight planning on transceiver 305 and/or other devices in communication with transmitter 303. The use can either wirelessly transmit the flight planning data to transmitter 303 or connect transmitter 303 directly to transceiver 305 and then thereafter connect transmitter 303 directly to avionics system 309. The user can then upload the flight planning information to avionics system 309. It will be appreciated that this process eliminates the need to manually enter flight planning information on avionics system 309, which commonly results in entry error.

It will be appreciated that system 301 provides the necessary link to facilitate the automatic download and/or upload of data to onboard avionics, without the need for specialized and dedicated onboard hardware. Also, the method of utilizing system 301 eliminates errors that can be caused by manual entry of flight planning information.

It will also be appreciated that the wireless connectivity discussed herein alleviates the need to remove/replace memory cards often, allows for easier integration with online/internet analysis solutions, improves user experience by integrating common devices into the solution. Another advantage of system 301 is that it uses non-aviation/off-board communication devices, e.g., transmitter 305 and computer 315, as the primary method, which allows for easier upgrades/improvements in hardware and software, as minimal qualification are required. Since the wireless communications is occurring through a standardized and controlled interface, e.g., writing data to transmitter 303, the onboard system is protected from malicious attacks to hardware through the wireless interface. The method also allows the data to be associated with the pilot/user via the transceiver 305 identity, removing the need for additional log-in and improve security with individual, unique pilot ID information.

In an alternative embodiment, it is contemplated utilizing a cable as means for data communication between transmitter 303 and avionics system 309. This embodiment could be utilized in aircraft that does not include ports for transmitter 303, e.g., a SD card port.

Utilizing system 301 as a training exercise is another contemplated method of use. For example, after flight, the flight performance information is sent to database 307 by one or more means discussed above, then thereafter reviewed by a flight instructor. Thereafter, the flight instructor can provide feedback based upon the flight performance data. It should be appreciated that one advantage of this method is to protect the privacy of the pilot's data so that only the instructor has access in lieu of multiple pilots having access. Confidentiality is often a requirement for many of the flight data monitoring programs normally imposed by pilot unions.

In one contemplated embodiment, computer 315 and transceiver 305 can be configured to communication directly with each other to provide feedback via automated rules. For example, computer 315 can process the data stored in database 307 and then transmit the analysis directly to the pilot on transceiver 305. This could take the form of individual events, e.g., “at 07:45, you conducted a banked turn of more than 30 degrees”, and/or through use of a scoring system such as a safety score, e.g., “Your Safety Score for this flight was an A; no negative conditions were found.”

It is apparent that a system and method with significant advantages has been described and illustrated. The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. An aircraft, comprising:
a sensor;
an avionics system associated with the sensor;
a wireless transmitter in data communication with the avionics system;
wherein the avionics system is configured to monitor aircraft flight performance data from the sensor; and
wherein the wireless transmitter is configured to wirelessly transmit aircraft flight performance data to the wireless database.

2. The aircraft of claim 1, further comprising:
a wireless transceiver in data communication with the wireless transmitter;
wherein the wireless transceiver is configured to receive and transmit aircraft flight performance data to the wireless database.

3. The aircraft of claim 2, wherein the wireless transceiver is portable.

4. The aircraft of claim 3, wherein the wireless transceiver is a smartphone.

5. The aircraft of claim 2, wherein the wireless transceiver is configured to transmit pilot identification to the wireless database.

6. The aircraft of claim 2, wherein the wireless transceiver is configured to upload data to the avionics system via the wireless transmitter.

7. The aircraft of claim 6, wherein the uploaded data is a flight planning data.

8. The aircraft of claim 2, wherein the wireless transmitter removably attaches to the wireless transceiver.

9. The aircraft of claim 1, wherein the wireless transmitter removably attaches to the avionics system.

10. The aircraft of claim 1, wherein the wireless transceiver is configured to receive and store aircraft flight performance data.

11. An aircraft flight performance monitoring system, comprising:
a wireless transmitter in data communication with an avionics system of the aircraft;
a portable wireless transceiver associated with the wireless transmitter; and
a wireless database associated with the wireless transmitter;
wherein the wireless transmitter is configured to receive and transmit flight performance data from the avionics system to the portable wireless transceiver, which in turn is transmitted to the wireless database.

12. The system of claim 11, wherein the wireless transmitter removable attaches to the avionics system.

13. The system of claim 12, wherein the wireless transceiver is configured to receive the wireless transmitter.

14. The system of claim 11, wherein the portable wireless transceiver is a smartphone.

15. The system of claim 11, wherein the portable wireless transceiver transmits pilot identification information to the wireless database.

16. The system of claim 11, further comprising:
a monitor conductively coupled to the wireless database;
wherein the monitor provides viewing access of flight performance data.

17. A method to monitor aircraft flight performance data, comprising:
sensing flight performance data with a sensor;
transmitting sensed flight performance data to a wireless transmitter;
wirelessly transmitting the sensed flight performance data to a wireless database; and
monitoring flight performance data with a display operably associated with the wireless database.

18. The method of claim 17, further comprising:
wirelessly transmitting the sensed data to a wireless transceiver operably associated with the database.

19. The method of claim 18, further comprising:
wirelessly transmitting pilot information to the database via the wireless transceiver.

20. The method of claim 18, further comprising:
removably attaching the wireless transmitter to the wireless transceiver.
